(19) United States
(12) Patent Application Publication
(10) Pub. No.: US 2025/0065950 A1
(43) Pub. Date: Feb. 27, 2025

(54) SNOWMOBILE STEERING SYSTEM

(71) Applicant: BOMBARDIER RECREATIONAL PRODUCTS INC., Valcourt (CA)

(72) Inventor: Janne TAPIO, Saarenkyla (FI)

(21) Appl. No.: 18/812,650

(22) Filed: Aug. 22, 2024

Related U.S. Application Data
(60) Provisional application No. 63/578,746, filed on Aug. 25, 2023.

(51) Int. Cl. B62D 7/20; B62M 27/02

(52) U.S. Cl. CPC B62D 7/20; B62M 27/02; B62M 2027/025; B62M 2027/027; B62M 2027/028

(57) ABSTRACT

A snowmobile has: a frame having a tunnel; a seat disposed at least in part over the tunnel; a motor supported by the frame; an endless drive track disposed at least in part under the tunnel, the endless drive track being driven by the motor; a steering system including a handlebar, the handlebar being pivotally connected to the frame; a left ski operatively connected to the steering system; and a right ski operatively connected to the steering system. The steering system is configured such that, in response to the handlebar being turned for making a left turn, the right ski is turned counterclockwise, as viewed from above the snowmobile, by a greater angle than the left ski; and in response to the handlebar being turned for making a right turn, the left ski is turned clockwise, as viewed from above the snowmobile, by a greater angle than the right ski.

### REFERENCE TO RELATED APPLICATION

The present application claims priority to U.S. Provisional Patent Application No. 63/578,746, filed Aug. 25, 2023, the entirety of which is incorporated herein by reference.

### TECHNICAL FIELD

The present technology relates to snowmobiles and steering systems for snowmobiles.

### BACKGROUND

Some snowmobile operators operate their snowmobiles in a maneuver known as side-hilling. Side-hilling is used when the snowmobile moves along the side of a hill (or mountain) such that the uphill direction of the hill is on one side of the snowmobile.

FIG. 1 illustrates an example of a snowmobile operator 10 on a snowmobile 12 performing side-hilling on a hill 14. The operator 10 actuates an accelerator (not shown) of the snowmobile 12 such that the snowmobile 12 moves along the side of the hill 14. As can be seen, as the snowmobile 12 moves along the side of the hill 14, the operator 10 tilts the snowmobile 12 toward an uphill side of the hill 14. To help maintain the snowmobile 12 tilted, the body of the operator 12 is positioned on the uphill side of the hill 14 so as to counterbalance the weight of the snowmobile 12, and the operator 12 counter-steers the snowmobile 12. To counter-steer the snowmobile 12, the operator 10 turns the handlebar 16 of the snowmobile 12 such that the front ends of the skis 18 of the snowmobile 12 point away from the side of the hill 14 as shown in FIG. 1. Depending on how steep the hill 14 is, the operator 10 may not have to completely get off the seat (not shown) of the snowmobile 12 in order to counterbalance the weight of the snowmobile 12. The angle by which the hill-side ski 18 (i.e. the left ski of the snowmobile 12 in the example of FIG. 1) also has an impact on how easy it is to maintain the side-hilling maneuver. The more the hill-side ski 18 can be turned, the easier side-hilling will be. As such, one way of making side-hilling easier consists in increasing the angle by which the hill-side ski 18 can be turned away from the hill 14.

One way of achieving this consists in allowing the handlebar 16 to be turned more. However, past a certain angle of turning of the handlebar 16, components of the steering system of the snowmobile 12 come into contact with other components of the snowmobile 12, thereby limiting by how much the handlebar 16 can be turned, and also potentially damaging the components of the snowmobile 12 that come into contact. To avoid this from happening, snowmobile manufacturers typically install stoppers to limit by how much the handlebar 16 can be turned.

Some ways to help the skis 18 to be turned more while preventing contact between components of the steering system of the snowmobile 12 and other components of the snowmobile 12 consist in changing the ski stance (i.e. the distance between the skis 18) and/or the degree of toe of the skis 18 (i.e. the angle between the skis 18 and a longitudinal line when the handlebar is steered to make the snowmobile 12 move straight ahead). However changing the ski stance and/or toe to increase the degree of turning of the skis 18 can have negative impacts on the balance and handling to the snowmobile 12 when not side-hilling.

With reference to FIGS. 2 to 4, a prior art steering system and associated components will be described.

Left and right front suspension assemblies 20 are connected between a chassis suspension module 22, which forms part of the frame of the snowmobile 12, and left and right ski legs 24. The front suspension assemblies 20 are double A-arm suspension assemblies 20. The front suspension assemblies 20 are connected to the ski legs 24 via upper and lower ball joints 26, 28. The balls 30, 32 of the upper and lower ball joints 26, 28 can be clearly seen on the left ski leg 24 shown in FIG. 4. The skis 18 are pivotally connected to the bottom of the ski legs 24 via pins 34 (shown in FIG. 3 for the left side) inserted through the skis 18 and apertures 36 defined in the bottom of the ski leg 24 (shown in FIG. 4 for the left ski leg 24).

A steering column 38 is pivotally supported by the chassis suspension module 22. The handlebar 16 connects to a top of the steering column 38. A pitman arm 40 is connected to a lower end of the steering column 38. Left and right tie rods 42 are pivotally connected between the pitman arm 40 and their respective ski legs 24. The tie rods 42 are pivotally connected to the pitman arm 40 via ball joints 44. The tie rods 42 pivot relative to the pitman arm 40 about separate axes 46. The tie rods 42 are pivotally connected to their respective ski legs 24 via ball joints 48. The ball 50 of the ball joint 48 of the left tie rod 42 can be clearly seen on the left ski leg 24 shown in FIG. 4. As can be seen in FIG. 3 for the left side of the steering system, with the handlebar 16 steered for the snowmobile 12 to move straight ahead, the pivot axis 52 about which the tie rod 42 pivots relative to the ski leg 24 is disposed laterally inward of a longitudinal centerline 54 of the ski 18.

As can be seen, there are many components that all move relative to each other during operation of the snowmobile 12, making any change to the steering system difficult as such changes may result in components coming into contact with each other.

In the above steering system, when the handlebar 16 is turned the ski 18 on the inside of the turn is turned by a greater angle than the ski 18 on the outside of the ski 18. For example, when making a right turn, the right ski 18 is turned clockwise by a greater angle than the left ski 18. This is known as Ackerman steering. As such, when side-hilling, as shown in FIG. 1, the ski 18 that is in the air, in this example the right ski 18, is turned more than the hill-side ski 18, in this case the left ski 18.

Therefore, there is a desire for a snowmobile having a steering system having an increased angle of steering of a hill-side ski for side-hilling.

### SUMMARY

It is an object of the present technology to ameliorate at least some of the inconveniences present in the prior art.

According to one aspect of the present technology, there is provided a snowmobile having: a frame having a tunnel; a seat disposed at least in part over the tunnel; a motor supported by the frame; an endless drive track disposed at least in part under the tunnel, the endless drive track being driven by the motor; a steering system including a handlebar, the handlebar being pivotally connected to the frame; a left ski operatively connected to the steering system; and a right ski operatively connected to the steering system. The steering system is configured such that, in response to the handlebar being turned for making a left turn, the right ski is turned counterclockwise, as viewed from above the snowmobile, by a greater angle than the left ski; and in response to the handlebar being turned for making a right turn, the left ski is turned clockwise, as viewed from above the snowmobile, by a greater angle than the right ski.

In some embodiments, the steering system further includes: a steering column connected to the handlebar; a pitman arm connected to a lower end of the steering column; a left ski leg connected to the left ski; a left tie rod pivotally connected between the left ski leg and the pitman arm; a right ski leg connected to the right ski; and a right tie rod pivotally connected between the right ski leg and the pitman arm.

In some embodiments, the left tie rod is pivotally connected to the pitman arm about a first axis; and the right tie rod is pivotally connected to the pitman arm about the first axis.

In some embodiments, a left arm pivotally connected to the pitman arm about the first axis; and a right arm pivotally connected to the pitman arm about the first axis. The left tie rod is pivotally connected to the pitman arm via the left arm. The right tie rod is pivotally connected to the pitman arm via the right arm.

In some embodiments, the left tie rod is pivotally connected to the left arm about a second axis; the right tie rod is pivotally connected to the right arm about a third axis; and the second and third axes are generally perpendicular to the first axis.

In some embodiments, the first axis extends more vertically than the second and third axes.

In some embodiments, in response to the handlebar being turned at its maximum for making the left turn, the right ski is turned counterclockwise, as viewed from above the snowmobile, by at least 2 degrees more than the left ski; and in response to the handlebar being turned at its maximum for making the right turn: the left ski is turned clockwise, as viewed from above the snowmobile, by at least 2 degrees more than the right ski.

In some embodiments, in response to the handlebar being turned at its maximum for making the left turn, the right ski is turned counterclockwise, as viewed from above the snowmobile, by at least 3 degrees more than the left ski; and in response to the handlebar being turned at its maximum for making the right turn, the left ski is turned clockwise, as viewed from above the snowmobile, by at least 3 degrees more than the right ski.

In some embodiments, in response to the handlebar being turned at its maximum for making the left turn, the right ski is turned counterclockwise, as viewed from above the snowmobile, by at least 32 degrees, and in response to the handlebar being turned at its maximum for making the right turn, the left ski is turned clockwise, as viewed from above the snowmobile, by at least 32 degrees.

In some embodiments, in response to the handlebar being turned at its maximum for making the left turn, the right ski is turned counterclockwise, as viewed from above the snowmobile, by at least 35 degrees; and in response to the handlebar being turned at its maximum for making the right turn, the left ski is turned clockwise, as viewed from above the snowmobile, by at least 35 degrees.

In some embodiments, the left tie rod is pivotally connected to the left ski leg about a left pivot axis; and the right tie rod is pivotally connected to the right ski leg about a right pivot axis. With the handlebar steered for the snowmobile to move straight ahead: the left pivot axis is disposed laterally outward of a longitudinal centerline of the left ski; and the right pivot axis is disposed laterally outward of a longitudinal centerline of the right ski.

According to another aspect of the present technology, there is provided a method for side-hilling a snowmobile having two skis comprising: actuating an accelerator of the snowmobile such that the snowmobile moves along a side of a hill; and tilting the snowmobile toward an uphill side of the hill. The method also comprises turning a handlebar of the snowmobile such that: front ends of the two skis of the snowmobile point away from the side of the hill; a hill-side ski of the two skis is turned by a first angle; another one of the two skis is turned by a second angle; and the first angle is greater than the second angle.

According to another aspect of the present technology, there is provided a snowmobile having: a frame having a tunnel; a seat disposed at least in part over the tunnel; a motor supported by the frame; an endless drive track disposed at least in part under the tunnel, the endless drive track being driven by the motor; a steering system; a left ski operatively connected to the steering system; and a right ski operatively connected to the steering system. The steering system includes: a handlebar pivotally connected to the frame; a steering column connected to the handlebar; a pitman arm connected to a lower end of the steering column; a left ski leg connected to the left ski; a left tie rod pivotally connected between the left ski leg and pitman arm, the left tie rod being pivotally connected to the left ski leg about a left pivot axis, the left tie rod being pivotally connected to the pitman arm about a first axis; a right ski leg connected to the right ski; and a right tie rod pivotally connected between the right ski leg and the pitman arm, the right tie rod being pivotally connected to the right ski leg about a right pivot axis, the right tie rod being pivotally connected to the pitman arm about the first axis. With the handlebar steered for the snowmobile to move straight ahead: the left pivot axis is disposed laterally outward of a longitudinal centerline of the left ski; and the right pivot axis is disposed laterally outward of a longitudinal centerline of the right ski.

In some embodiments, a left arm pivotally connected to the pitman arm about the first axis; and a right arm pivotally connected to the pitman arm about the first axis. The left tie rod is pivotally connected to the pitman arm via the left arm. The right tie rod is pivotally connected to the pitman arm via the right arm.

In some embodiments, the left tie rod is pivotally connected to the left arm about a second axis; the right tie rod is pivotally connected to the right arm about a third axis; and the second and third axes are generally perpendicular to the first axis.

In some embodiments, the first axis extends more vertically than the second and third axes.

In some embodiments, in response to the handlebar being turned at its maximum for making a left turn, the right ski is turned counterclockwise, as viewed from above the snowmobile, by at least 2 degrees more than the left ski; and in response to the handlebar being turned at its maximum for making a right turn, the left ski is turned clockwise, as viewed from above the snowmobile, by at least 2 degrees more than the right ski.

In some embodiments, in response to the handlebar being turned at its maximum for making the left turn: the right ski is turned counterclockwise, as viewed from above the snowmobile, by at least 3 degrees more than the left ski; and in response to the handlebar being turned at its maximum for making the right turn, the left ski is turned clockwise, as viewed from above the snowmobile, by at least 3 degrees more than the right ski

In some embodiments, in response to the handlebar being turned at its maximum for making the left turn, the right ski is turned counterclockwise, as viewed from above the snowmobile, by at least 32 degrees; and in response to the handlebar being turned at its maximum for making the right turn, the left ski is turned clockwise, as viewed from above the snowmobile, by at least 32 degrees.

In some embodiments, in response to the handlebar being turned at its maximum for making the left turn, the right ski is turned counterclockwise, as viewed from above the snowmobile, by at least 35 degrees; and in response to the handlebar being turned at its maximum for making the right turn, the left ski is turned clockwise, as viewed from above the snowmobile, by at least 35 degrees.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

For purposes of the present application, terms related to spatial orientation when referring to a vehicle and components in relation to the vehicle, such as “vertical”, “horizontal”, “forwardly”, “rearwardly”, “left”, “right”, “above” and “below”, are as they would be understood by a driver of the vehicle sitting thereon in an upright driving position, with the vehicle steered straight-ahead and being at rest on flat, level ground.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is an illustration of a snowmobile and its rider during side-hilling;

FIG. 2 is a rear perspective view of a portion of a frame, skis, steering system and front suspension system of a prior art snowmobile;

FIG. 3 is a close-up top view of a left ski region of the components of FIG. 2;

FIG. 4 is a perspective view, taken from a rear, right side, of a left ski leg of the components of FIG. 2;

FIG. 5 is a left side elevation view of a snowmobile according to the present technology;

FIG. 6 is a perspective view taken from a rear, right side of a portion of a frame, skis, steering system and front suspension system of the snowmobile of FIG. 5, with the steering system being steered to move straight ahead;

FIG. 7 is a rear elevation view of the components of FIG. 6;

FIG. 8 is a left side elevation view of the components of FIG. 6;

FIG. 9 is a top plan view of the components of FIG. 6;

FIG. 10 is a close-up top view of a left ski region of the components of FIG. 6;

FIG. 11 is a top plan view of the components of FIG. 6, with the steering system being steered for making a right turn;

FIG. 12 is a rear elevation view of the components of FIG. 11;

FIG. 13 is a top plan view of the components of FIG. 6, with the steering system being steered for making a left turn;

FIG. 14 is a perspective view, taken from a rear, right side, of a left ski leg of the components of FIG. 6;

FIG. 15 is a left side elevation view of the left ski leg of FIG. 14;

FIG. 16 is a top plan view of the left ski leg of FIG. 14;

FIG. 17 is a rear elevation view of the left ski leg of FIG. 14;

FIG. 18 is a front elevation view of the left ski leg of FIG. 14;

FIG. 19 is a perspective view, taken from a rear, left side, of a steering column, pitman arm, arms, and tie rods of the components of FIG. 6, with the steering column being steered to move straight ahead; and

FIG. 20 is a close-up top view of a pitman arm region of the components of FIG. 19.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

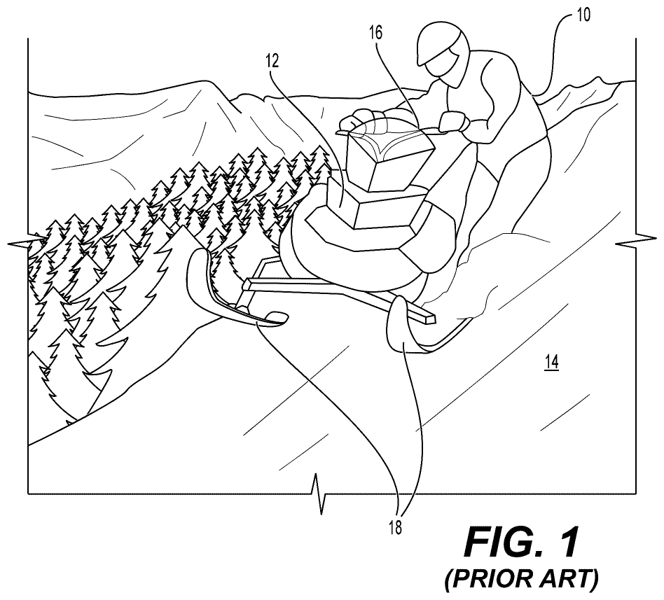

The present technology will be described with reference to the snowmobile 100 of FIG. 1. The snowmobile 100 has a front end 102 and a rear end 104 which are defined consistently with a travel direction of the snowmobile 100. The snowmobile 100 includes a vehicle body in the form of a frame 106 which includes a tunnel 108, a motor module 110, and a chassis suspension module 112. The tunnel 108 is formed from sheet metal parts assembled to form an inverted U-shape when viewed from the front or rear end 102, 104.

A motor 114, schematically illustrated, is supported in a motor compartment defined by the motor module 110 of the frame 106 and provides, in part, propulsion of the snowmobile 100. In the illustrated embodiment, the motor 114 is an internal combustion engine 114, but it is contemplated that it could be, for example, an electric motor.

An endless drive track 116 (shown schematically) is positioned generally under the tunnel 108 and is operatively connected to the motor 114 via a drivetrain including a belt transmission system (not shown). The endless drive track 116 is driven to run about a rear suspension assembly 118 connected to the frame 106 for propulsion of the snowmobile 100.

The rear suspension assembly 118 includes multiple idler wheels 120 and a pair of slide rails 122 in sliding contact with the endless drive track 116. The slide rails 122 are attached to the tunnel 108 by a front suspension arm 124 and a rear suspension arm 126. A front shock absorber assembly 128 and a rear shock absorber 130 with adjacent torsion springs 132 bias the slide rails 122 away from the tunnel 108.

A fuel tank 134 is disposed on top of the tunnel 108. A straddle seat 136 is positioned on top of the fuel tank 134. As such, the seat 136 is supported by the tunnel 108. The seat 136 is adapted to accommodate the user of the snowmobile 100. A footrest 138 is positioned on each side of the snowmobile 100 below the seat 136 to accommodate the user's feet. Each of the left and right footrests 138 extends generally laterally outwardly from the sides of the tunnel 108. In the illustrated embodiment, each side portion of the tunnel 108 is bent laterally outwardly at its bottom edge to form the corresponding footrest 138. It is however contemplated that the footrest 138 could be formed separately from and be connected to the tunnel 108.

At the front end 102 of the snowmobile 100, body panels 140 enclose the motor 114 and other components of the powerpack such as a transmission or air intake system. The body panels 140 include a hood 142 which can be removed/opened to allow access to the motor 114 and other internal components of the snowmobile 100 from the top and the front which may be required, for example, for inspection or maintenance of the motor 114 and/or the powerpack. The body panels 140 also include two side panels 144 extending along the left and right sides of the snowmobile 100. The side panels 144 are both removably connected to the frame 106 and/or to other body panels 140 and can be removed/opened to access the internal components from the corresponding lateral side.

Two skis 150 positioned at the forward end 102 of the snowmobile 100 are attached to the chassis suspension module 112 through front suspension assemblies 152. The front suspension assemblies 152 will be described in more detail below.

A steering system is provided to steer the skis 150. The steering system includes a handlebar 154 disposed forward of the seat 136. The handlebar 154 is operatively connected to ski legs 156 as will be described in more detail below. The ski legs 156 are pivotally connected to the skis 150. The handlebar 54 is used to rotate the ski legs 156, and thereby the skis 150, in order to steer the snowmobile 100. A wind deflector 158 is provided in front of the handlebar 154.

The snowmobile 100 includes other components such as a display cluster, an exhaust system, an air intake system, and the like. As it is believed that these components would be readily recognized by one of ordinary skill in the art, further explanation and description of these components will not be provided herein.

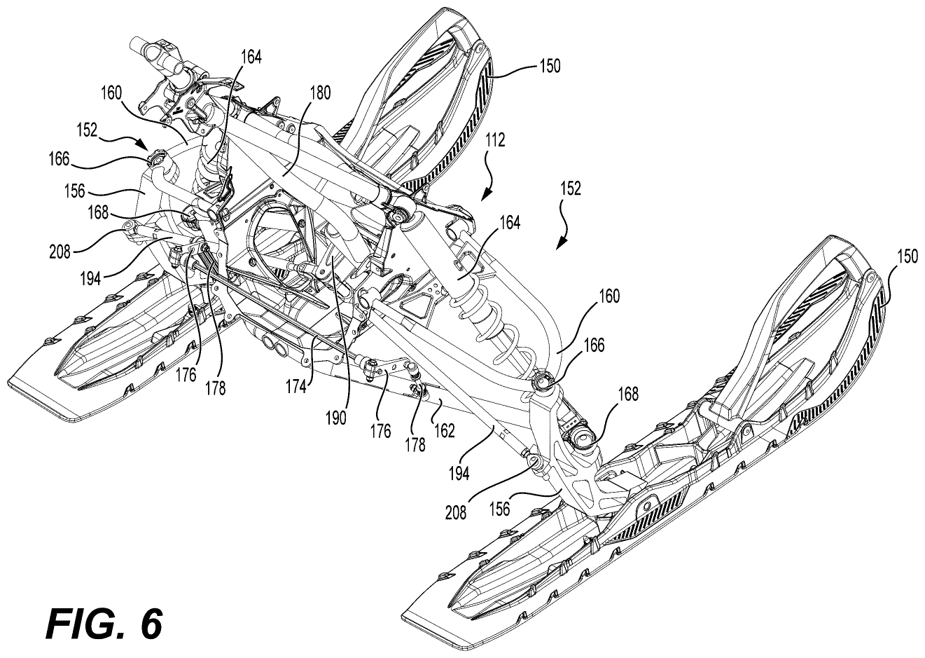

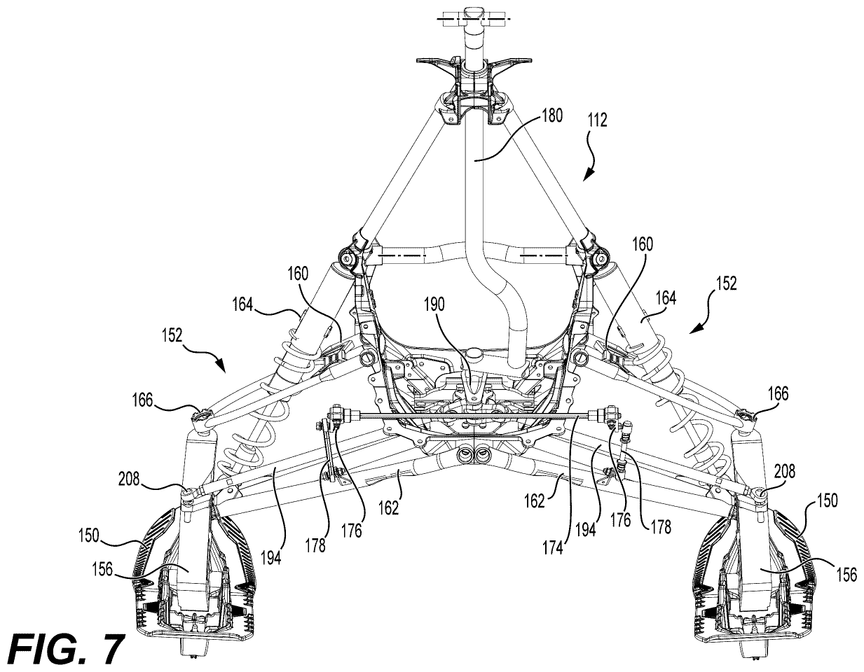

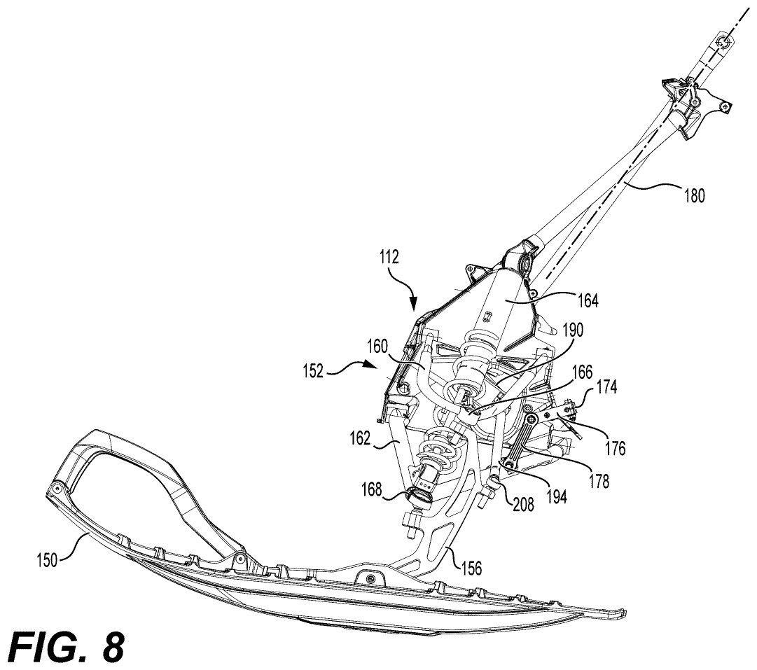

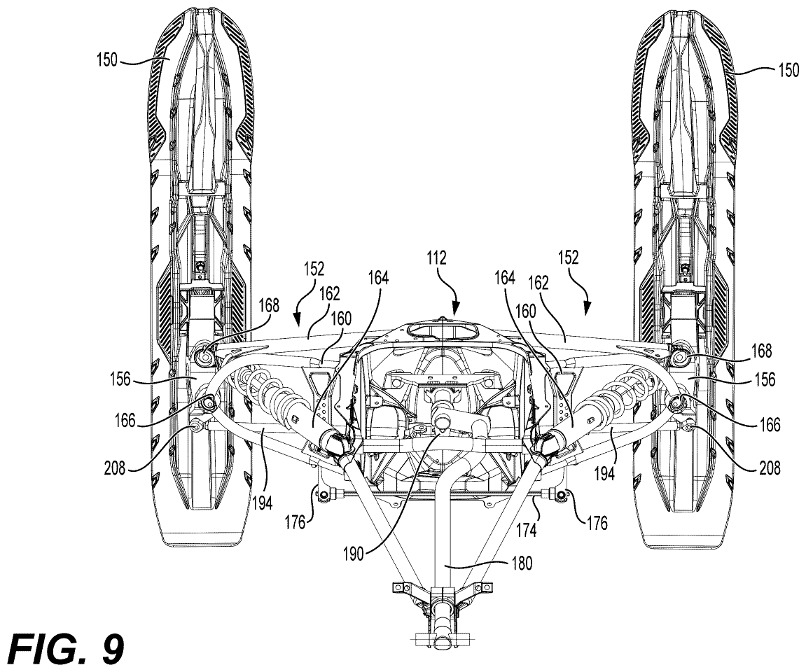

Turning now to FIGS. 6 to 10, the front suspension assemblies 152 will be described in more detail. The front suspension assemblies 152 are double A-arm suspension assemblies 152. As the left and right front suspension assemblies 152 are mirror images of each other, only the left front suspension assembly 152 will be described below. Corresponding elements of the right front suspension assembly 152 have been labeled with the same reference numerals as the component of the left front suspension assembly 152.

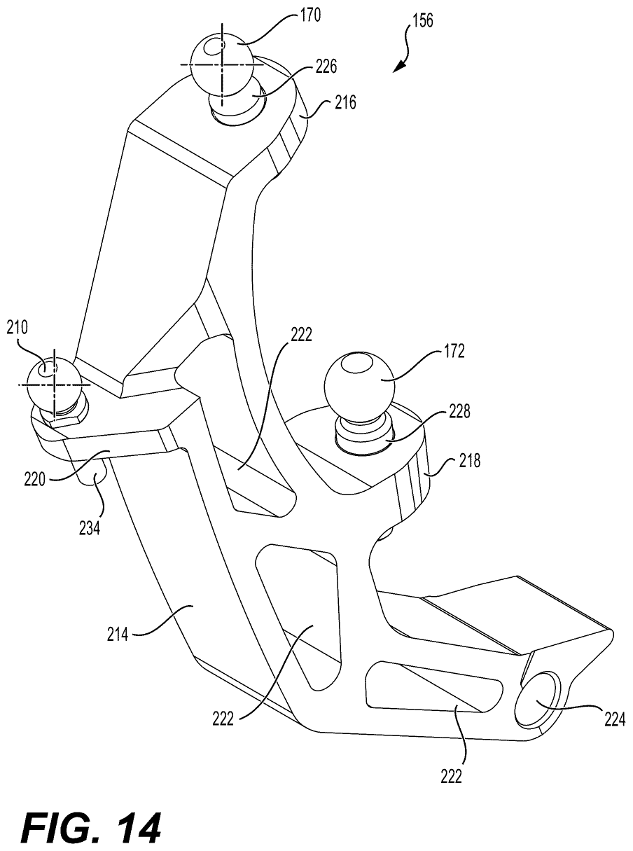

The left suspension assembly 152 has an upper A-arm 160, a lower A-arm 162, and a shock absorber assembly 164. The right ends of the upper and lower A-arms 160, 162 are pivotally connected to the left side of the chassis suspension module 112. The left ends of the upper and lower A-arms 160, 162 are pivotally connected to the left ski leg 156 via upper and lower ball joints 166, 168. The balls 170, 172 of the upper and lower ball joints 166, 168 can be clearly seen on the left ski leg 156 in FIG. 14. The shock absorber assembly 164 is pivotally connected at its upper end to the left side of the chassis suspension module 112 and at its lower end to the lower A-arm 162.

A torsion bar 174 is connected between the lower A-arms 162 of the left and right front suspension assemblies 152. Arms 176 are pivotally connected to the ends of the torsion bar 174. Rods 178 pivotally connect the arms 176 to the lower A-arms 162.

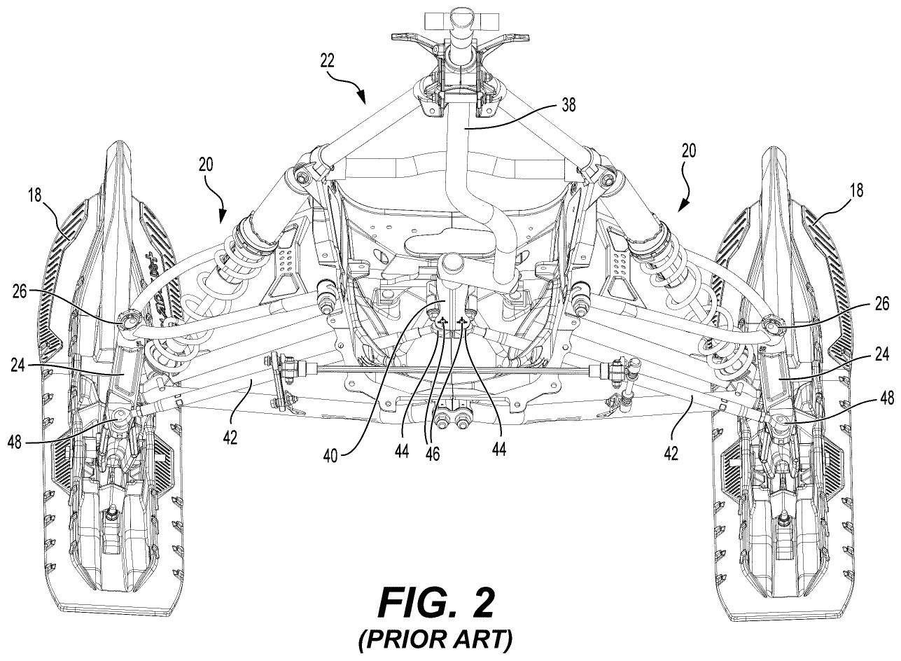

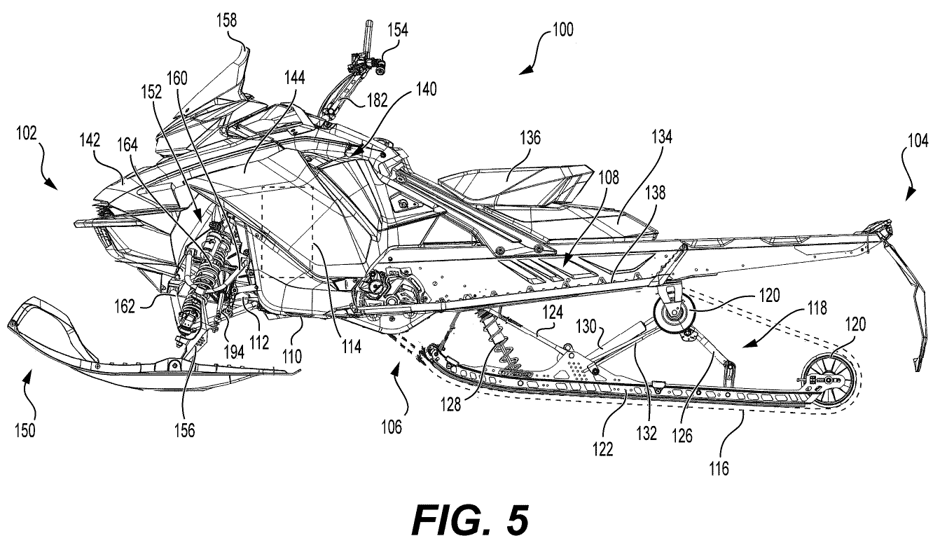

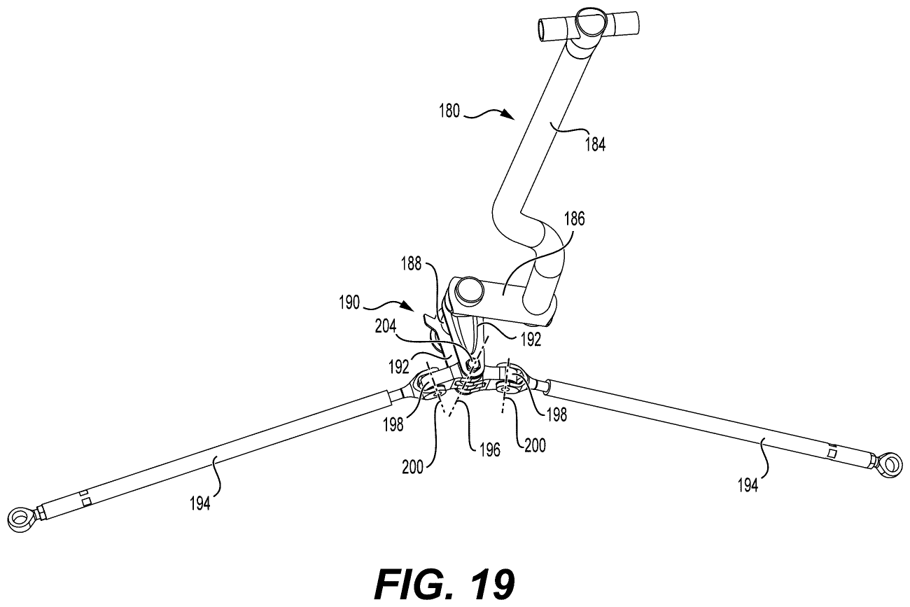

The steering system will now be described in more detail with reference to FIGS. 5 to 10, 19 and 20. A steering column 180 is pivotally supported by the chassis suspension module 112. The handlebar 154 connects to a top of the steering column 180 via a steering column extension 182 (FIG. 2). It is contemplated that the steering column extension 182 could be omitted and that the handlebar 154 could be connected directly to the top of the steering column 180. With reference to FIG. 19, the steering column 180 has three portions 184, 186, 188. The portion 184, which include the top end of the steering column 180, has an upper straight section and a lower curved section. The portion 186 is connected to the lower end of the portion 184 and extend perpendicularly therefrom. The portion 188, which includes the lower end of the steering column 180, connects to the end of the portion 186. The portion 188 and the upper straight section of the portion 184 are co-axial. The steering column 180 has the shape shown to provide space for other components of the snowmobile 100. It is contemplated that the steering column 180 could have other shapes. For example, it is contemplated that the steering column 180 could be a single straight tube.

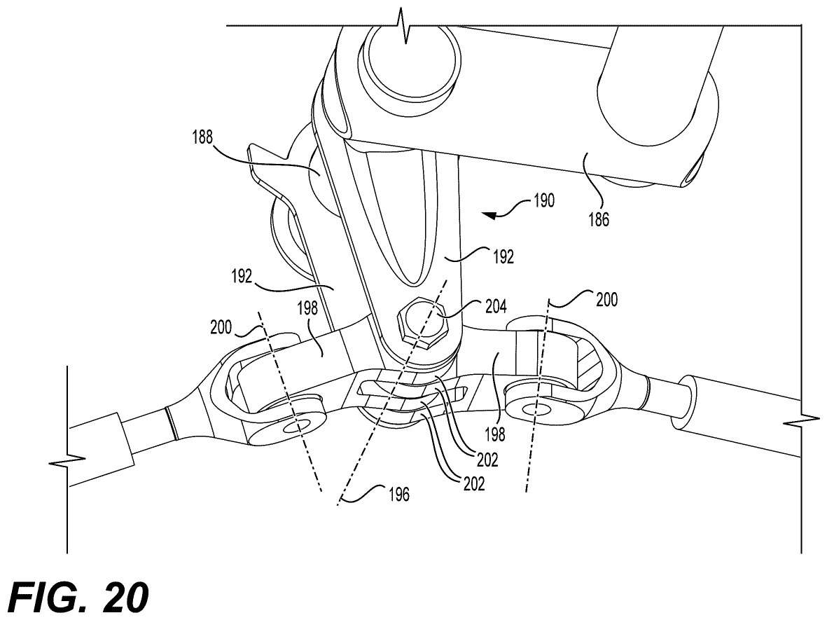

A pitman arm 190 is connected to the lower end of the steering column 180. With the handlebar 154 steered for the snowmobile 100 to move straight ahead, as in FIGS. 5 to 10, 19 and 20, the pitman arm 190 extends rearward from the portion 188 of the steering column 180. The pitman arm 190 is rotationally fixed relative to the steering column 180 such that when the steering column 180 turns, the pitman arm 190 turns with it. As best seen in FIG. 20, the pitman arm 190 has upper and lower parts 192 that are spaced from one another.

Left and right tie rods 194 are pivotally connected between the pitman arm 190 and their respective ski legs 156. As best seen in FIGS. 19 and 20, the tie rods 194 are pivotally connected to the pitman arm 190 about the same axis 196. More specifically, the inner ends of the left and right tie rods 194 are pivotally connected to left and right arms 198 that are connected to the pitman arm 190 about the axis 196. Each tie rod 194 pivotally connects to its respective arm 198 about an axis 200. The axes 200 are generally perpendicular to the axis 196. The axis 196 extends more vertically than the axes 200. As can be seen in FIG. 20, each arm 198 has two fingers 202. The fingers 202 of the arms 198 interlace and are received between the upper and lower parts 192 of the pitman arm 190. A bolt 204 extends through the part 192 of the pitman arm 190 and the fingers 202 of the arms 198.

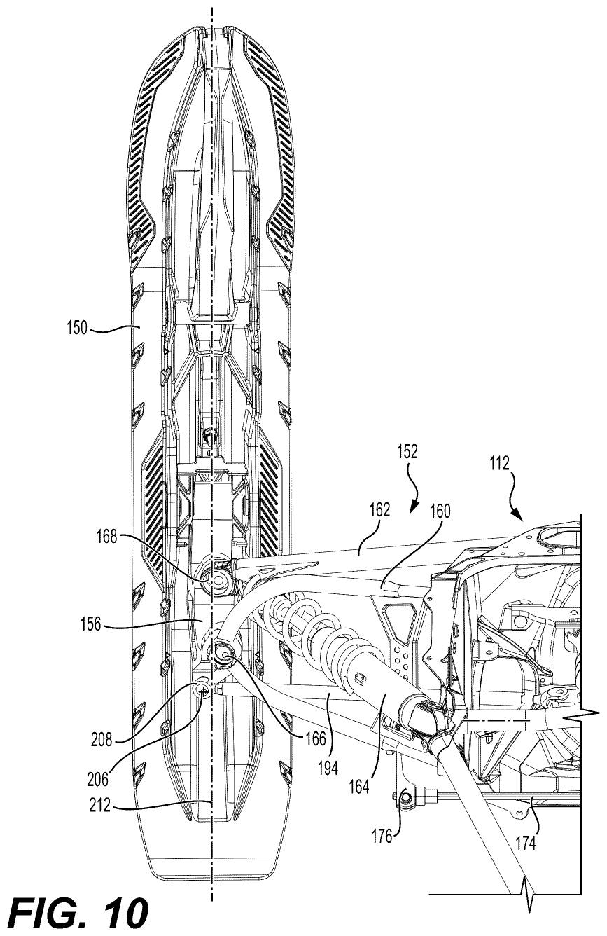

The outer ends of the left and right tie rods 194 are pivotally connected to their respective ski legs 156 about left and right pivots axes 206 (shown in FIG. 10 for the left tie rod 194) via ball joints 208. The ball 210 of the ball joint 208 of the left tie rod 194 can be clearly seen on the left ski leg 156 in FIG. 14. The pivot axes 206 pass through the centers of the balls 210 of their respective ball joints 208. As can be seen in FIG. 10 for the left side of the steering system, with the handlebar 154 steered for the snowmobile 100 to move straight ahead, the pivot axis 206 about which the tie rod 194 pivots relative to the ski leg 156 is disposed laterally outward of a longitudinal centerline 212 of the ski 150.

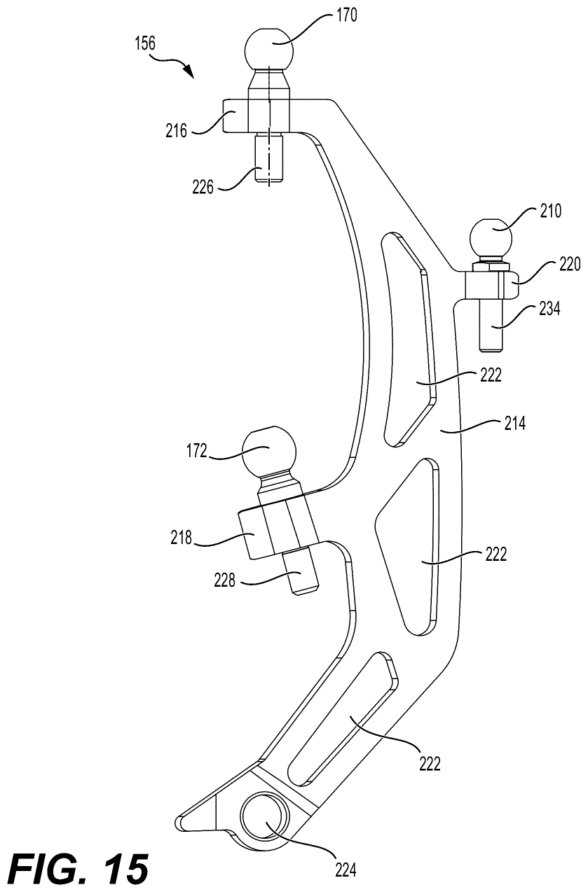

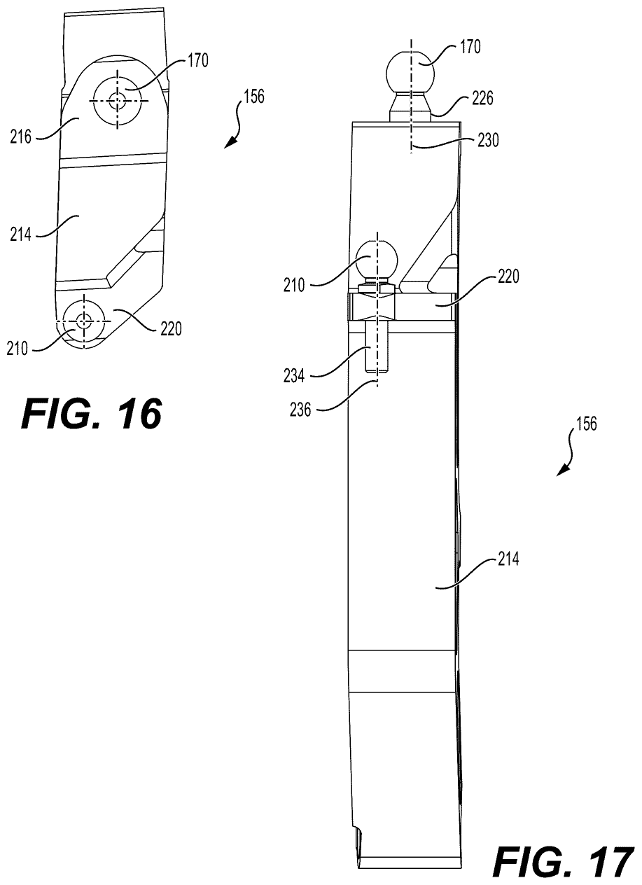

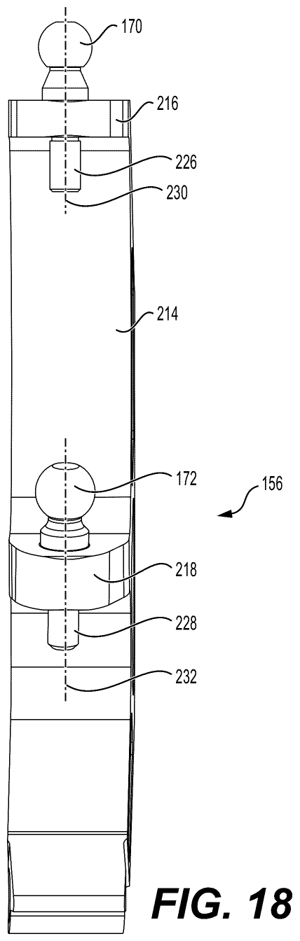

Turning now to FIGS. 14 to 18, the left ski leg 156 will be described in more detail. The right ski leg 156 is a mirror image of the left ski leg 156. The ski leg 156 has a ski leg body 214 and tabs 216, 218, 220 integrally formed with the ski leg body 214. The ski leg body 214 is generally hockey stick shaped. The ski leg body 214 has hollowed out portions 222 for weight reduction. It is contemplated the hollowed portions 222 could be omitted. An aperture 224 is defined in a lower end of the ski leg body 214. The ski 150 is pivotally connected to the bottom of the ski legs 156 via a pin (not shown) inserted through the ski 150 and the apertures 224 defined in the bottom of the ski leg 156. The tab 216 extends forward of the ski leg body 214 from a top end thereof. A threaded shank 226 integrally formed with the ball 170 is threaded through the tab 216 to fasten the ball 170 to the tab 216. The tab 218 extends forward of the ski leg body 214 vertically below the tab 216. A threaded shank 228 integrally formed with the ball 172 is threaded through the tab 218 to fasten the ball 172 to the tab 218. As can be seen in FIG. 18, the axes 230, 232 of the shanks 226, 228 are laterally aligned. The tab 220 extends rearward of the ski leg body 214. A threaded shank 234 integrally formed with the ball 210 is threaded through the tab 220 to fasten the ball 210 to the tab 220. As can be seen in FIG. 17, the axis 236 of the shank 234 is disposed laterally to the left of the axis 230 of the shank 226. As such, the center of the ball 210 is disposed laterally outward (i.e. to the left) of the center of the balls 170, 172 with the handlebar 154 steered for the snowmobile 100 to move straight ahead. When the handlebar 154 is turned to steer the ski 150, the ski leg 156 turns about an axis passing through the centers of the balls 170, 172.

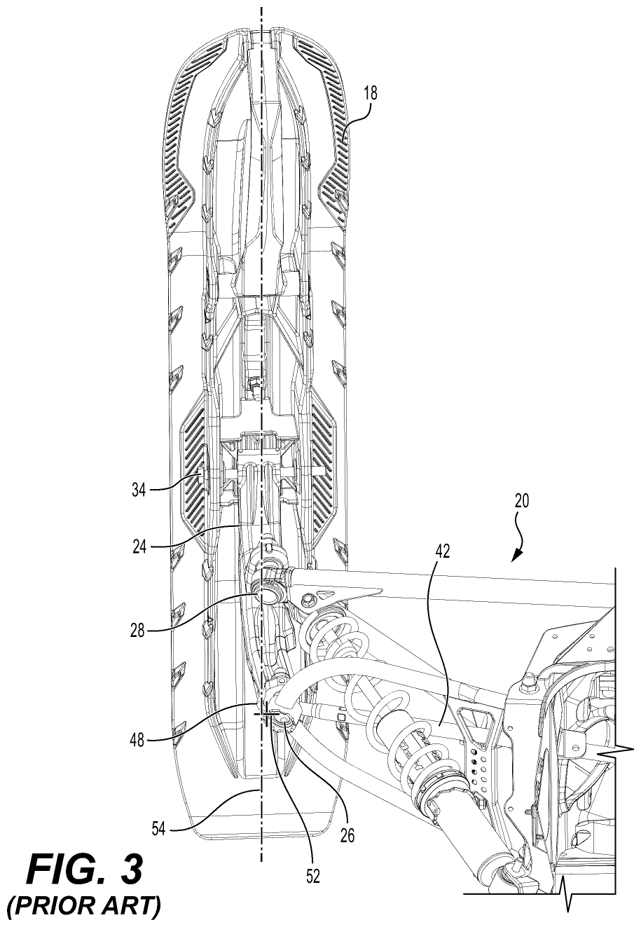

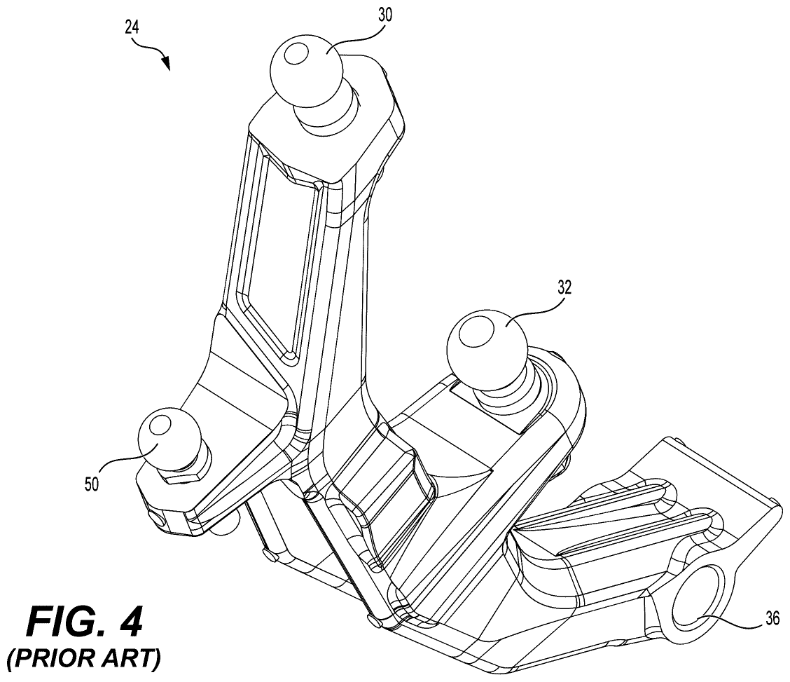

When the handlebar 154 is turned, the steering column 180 and the pitman arm 190 turn in the same direction as the handlebar 154, and the pitman arm 190 pushes on one of the tie rods 194 and pulls on the other one of the tie rods 194. As a result, the ski legs 156 and the skis 150 are turned. In the present steering system, the ski 150 that is on the outside of the turn is turned by a greater angle than the ski 150 that is on the inside of the turn. This is the opposite of what happens in the prior art system described above with respect to the snowmobile 12 in FIGS. 1 to 4 (i.e. the ski 18 that is on the outside of the run is turned by a smaller angle than the ski 18 that is on the inside of the turn). As such, with the position of the ski legs 24 relative to the steering column 38 being the same as the position of the ski legs 156 relative to the steering column 180, for the same degree of turning of the handlebars 16, 154, the ski 150 on the outside of the turn of the present technology turns by a greater angle than the ski 18 on the outside of the turn of the prior art. As such, as previously explained, the steering system of the present technology is advantageous when side-hilling.

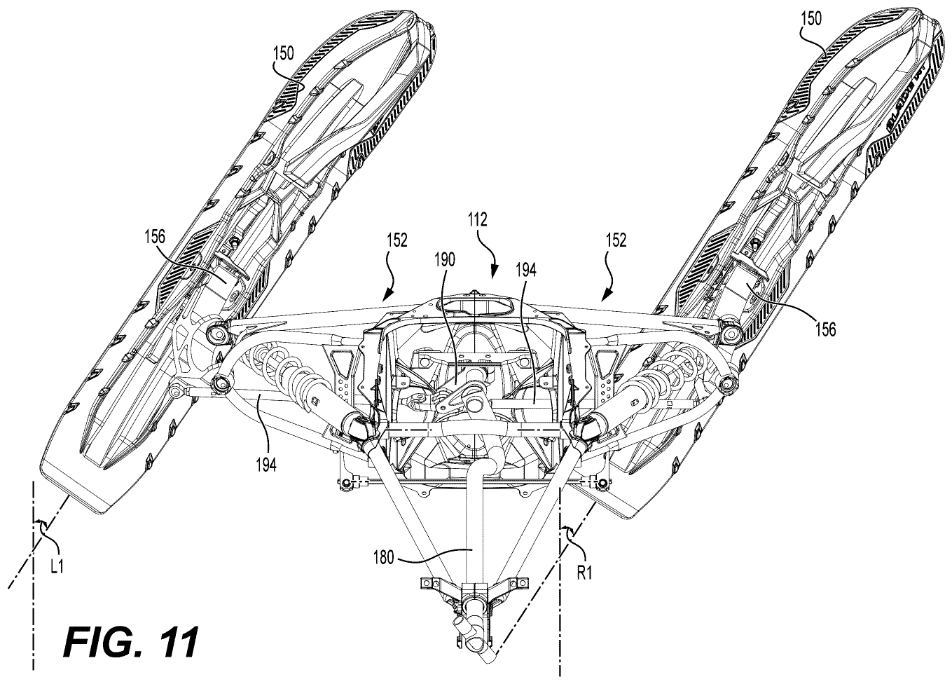

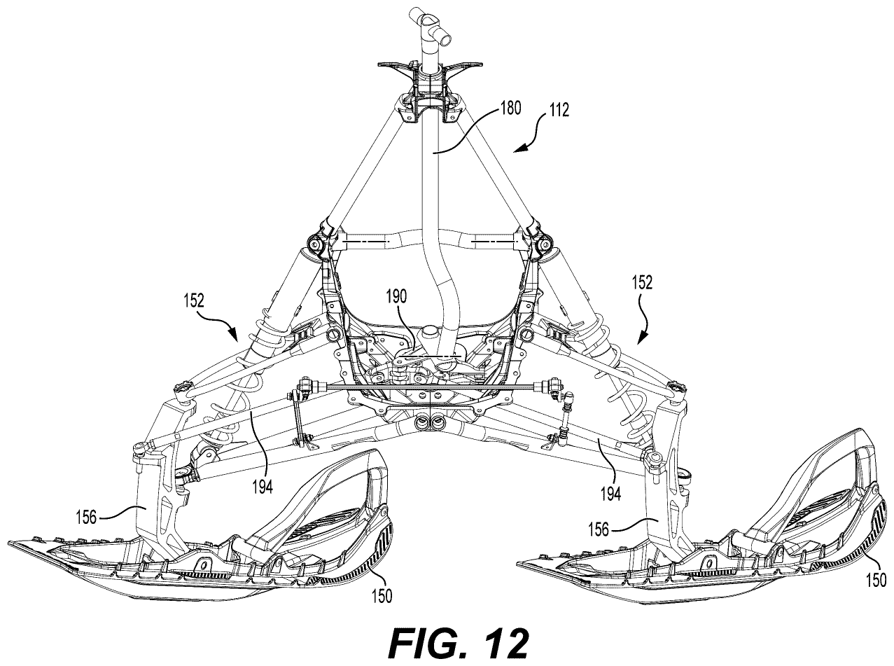

With reference to FIGS. 11 and 12, in response to the handlebar 154 being turned at its maximum for making a right turn, the pitman arm 190 pushes the left tie rod 194 to the left and pulls the right tie rod 194 to the left. As a result, as viewed from above the snowmobile 100 as in FIG. 11, the ski legs 156 and the skis 150 are turned clockwise. The left ski 150 is turned by an angle L1 and the right ski 150 is turned by an angle R1. In some embodiments, the angle L1 is at least 2 degrees more than the angle R1. In some embodiments, the angle L1 is at least 3 degrees more than the angle R1. In some embodiment, the angle L1 is at least 32 degrees. In some embodiment, the angle L1 is at least 35 degrees. In the present embodiment the angle L1 is 36 degrees and the angle R1 is 33 degrees, but other angles are contemplated.

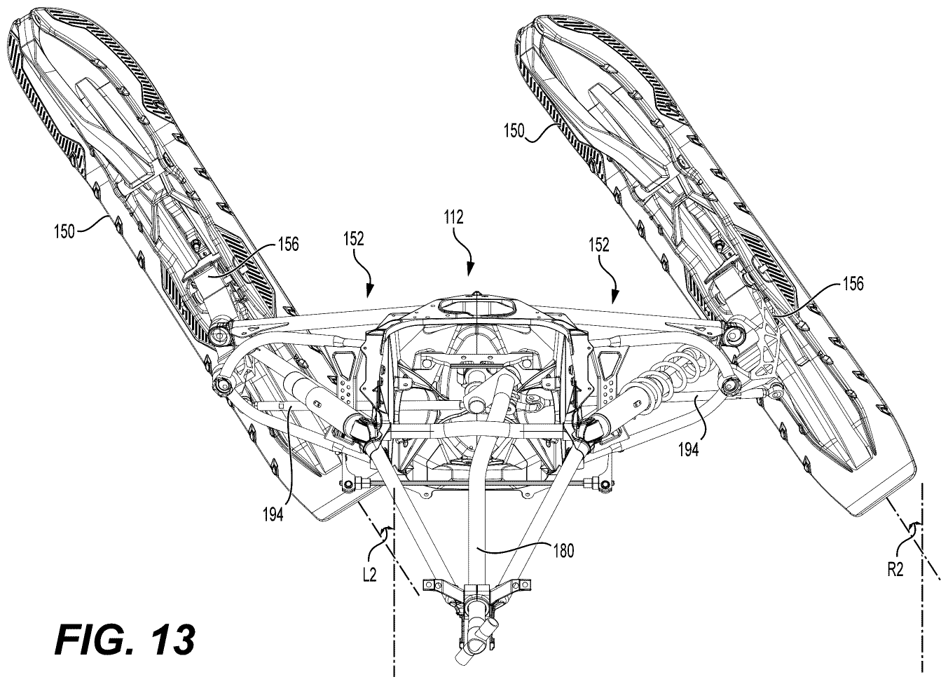

With reference to FIG. 13, in response to the handlebar 154 being turned at its maximum for making a left turn, the pitman arm 190 pushes the right tie rod 194 to the right and pulls the left tie rod 194 to the right. As a result, as viewed from above the snowmobile 100 as in FIG. 13, the ski legs 156 and the skis 150 are turned counterclockwise. The left ski 150 is turned by an angle L2 and the right ski 150 is turned by an angle R2. In some embodiments, the angle R2 is at least 2 degrees more than the angle L2. In some embodiments, the angle R2 is at least 3 degrees more than the angle L2. In some embodiment, the angle R2 is at least 32 degrees. In some embodiment, the angle R2 is at least 35 degrees. In the present embodiment the angle R2 is 36 degrees and the angle L2 is 33 degrees, but other angles are contemplated.

For performing side-hilling with the snowmobile 100, the operator of the snowmobile 100 actuates an accelerator (not shown) provided on a right side of the handlebar 154 such that the snowmobile 100 moves along the side of the hill. As the snowmobile 100 moves along the side of the hill, the operator tilts the snowmobile 100 toward an uphill side of the hill, as in the prior art shown in FIG. 1. To help maintain the snowmobile 100 tilted, the body of the operator is positioned on the uphill side of the hill so as to counterbalance the weight of the snowmobile 100, and the operator counter-steers the snowmobile 100. To counter-steer the snowmobile 100, the operator turns the handlebar 154 of the snowmobile 100 such that the front ends of the skis 150 point away from the side of the hill. As a result of the steering system of the present technology, the hill-side ski 150 is turned by a greater angle than the other ski 150. This is advantageous because for the distance between the skis 150 of the snowmobile 100 being the same as the distance between the skis 18 of the prior art snowmobile 12, for the same degree of turning of the handlebars 16, 154, the hill-side ski 150 of the snowmobile 100 will turn away from the hill by a greater angle than the hill-side ski 18 of the snowmobile 12.

Modifications and improvements to the above-described embodiments of the present invention may become apparent to those skilled in the art. The foregoing description is intended to be exemplary rather than limiting. The scope of the present invention is therefore intended to be limited solely by the appended claims.

What is claimed is:

1. A snowmobile comprising:
a frame having a tunnel;
a seat disposed at least in part over the tunnel;
a motor supported by the frame;
an endless drive track disposed at least in part under the tunnel, the endless drive track being driven by the motor;
a steering system including a handlebar, the handlebar being pivotally connected to the frame;
a left ski operatively connected to the steering system;
a right ski operatively connected to the steering system,
the steering system being configured such that:
in response to the handlebar being turned for making a left turn:
the right ski is turned counterclockwise, as viewed from above the snowmobile, by a greater angle than the left ski; and
in response to the handlebar being turned for making a right turn:
the left ski is turned clockwise, as viewed from above the snowmobile, by a greater angle than the right ski.

2. The snowmobile of claim 1, wherein the steering system further includes:
a steering column connected to the handlebar;
a pitman arm connected to a lower end of the steering column;
a left ski leg connected to the left ski;
a left tie rod pivotally connected between the left ski leg and the pitman arm;
a right ski leg connected to the right ski; and
a right tie rod pivotally connected between the right ski leg and the pitman arm.

3. The snowmobile of claim 1, wherein:
in response to the handlebar being turned at its maximum for making the left turn:
the right ski is turned counterclockwise, as viewed from above the snowmobile, by at least 2 degrees more than the left ski; and
in response to the handlebar being turned at its maximum for making the right turn:
the left ski is turned clockwise, as viewed from above the snowmobile, by at least 2 degrees more than the right ski.

4. The snowmobile of claim 3, wherein:
in response to the handlebar being turned at its maximum for making the left turn:
the right ski is turned counterclockwise, as viewed from above the snowmobile, by at least 3 degrees more than the left ski; and
in response to the handlebar being turned at its maximum for making the right turn:
the left ski is turned clockwise, as viewed from above the snowmobile, by at least 3 degrees more than the right ski.

5. The snowmobile of claim 3, wherein:
in response to the handlebar being turned at its maximum for making the left turn:
the right ski is turned counterclockwise, as viewed from above the snowmobile, by at least 32 degrees; and
in response to the handlebar being turned at its maximum for making the right turn:
the left ski is turned clockwise, as viewed from above the snowmobile, by at least 32 degrees.

6. The snowmobile of claim 5, wherein:
in response to the handlebar being turned at its maximum for making the left turn:
the right ski is turned counterclockwise, as viewed from above the snowmobile, by at least 35 degrees; and
in response to the handlebar being turned at its maximum for making the right turn:
the left ski is turned clockwise, as viewed from above the snowmobile, by at least 35 degrees.

7. The snowmobile of claim 1, wherein:
the left tie rod is pivotally connected to the left ski leg about a left pivot axis;
the right tie rod is pivotally connected to the right ski leg about a right pivot axis; and
with the handlebar steered for the snowmobile to move straight ahead:
the left pivot axis is disposed laterally outward of a longitudinal centerline of the left ski; and
the right pivot axis is disposed laterally outward of a longitudinal centerline of the right ski.

8. A method for side-hilling a snowmobile having two skis comprising:
actuating an accelerator of the snowmobile such that the snowmobile moves along a side of a hill;
tilting the snowmobile toward an uphill side of the hill; and
turning a handlebar of the snowmobile such that:
front ends of the two skis of the snowmobile point away from the side of the hill;
a hill-side ski of the two skis is turned by a first angle;
another one of the two skis is turned by a second angle; and
the first angle is greater than the second angle.

9. A snowmobile comprising:
a frame having a tunnel;
a seat disposed at least in part over the tunnel;
a motor supported by the frame;
an endless drive track disposed at least in part under the tunnel, the endless drive track being driven by the motor;
a steering system;
a left ski operatively connected to the steering system; and
a right ski operatively connected to the steering system,
the steering system including:
a handlebar pivotally connected to the frame;
a steering column connected to the handlebar;
a pitman arm connected to a lower end of the steering column;
a left ski leg connected to the left ski;
a left tie rod pivotally connected between the left ski leg and the pitman arm, the left tie rod being pivotally connected to the left ski leg about a left pivot axis, the left tie rod being pivotally connected to the pitman arm about a first axis;
a right ski leg connected to the right ski; and
a right tie rod pivotally connected between the right ski leg and the pitman arm, the right tie rod being pivotally connected to the right ski leg about a right pivot axis, the right tie rod being pivotally connected to the pitman arm about the first axis,
with the handlebar steered for the snowmobile to move straight ahead:
the left pivot axis being disposed laterally outward of a longitudinal centerline of the left ski; and
the right pivot axis being disposed laterally outward of a longitudinal centerline of the right ski.

10. The snowmobile of claim 9, wherein:
in response to the handlebar being turned at its maximum for making a left turn:
the right ski is turned counterclockwise, as viewed from above the snowmobile, by at least 2 degrees more than the left ski; and
in response to the handlebar being turned at its maximum for making a right turn:
the left ski is turned clockwise, as viewed from above the snowmobile, by at least 2 degrees more than the right ski.

11. The snowmobile of claim 10, wherein:
in response to the handlebar being turned at its maximum for making the left turn:
the right ski is turned counterclockwise, as viewed from above the snowmobile, by at least 3 degrees more than the left ski; and
in response to the handlebar being turned at its maximum for making the right turn:
the left ski is turned clockwise, as viewed from above the snowmobile, by at least 3 degrees more than the right ski.

12. The snowmobile of claim 10, wherein:
in response to the handlebar being turned at its maximum for making the left turn:
the right ski is turned counterclockwise, as viewed from above the snowmobile, by at least 32 degrees; and
in response to the handlebar being turned at its maximum for making the right turn:
the left ski is turned clockwise, as viewed from above the snowmobile, by at least 32 degrees.

13. The snowmobile of claim 12, wherein:
in response to the handlebar being turned at its maximum for making the left turn:
the right ski is turned counterclockwise, as viewed from above the snowmobile, by at least 35 degrees; and
in response to the handlebar being turned at its maximum for making the right turn:
the left ski is turned clockwise, as viewed from above the snowmobile, by at least 35 degrees.
